(19) United States
(12) Patent Application Publication
(10) Pub. No.: US 2005/0073620 A1
(43) Pub. Date: Apr. 7, 2005

(54) Active matrix substrate and display device having the same

(75) Inventors: Masahito Gotoh, Matsusaka-shi (JP); Tohru Ueda, Matsusaka-shi (JP)

Correspondence Address: Keating & Bennett LLP, Suite 312, 10400 Eaton Place, Fairfax, VA, 22030, US

(73) Assignee: SHARP KABUSHIKI KAISHA, Osaka (JP)

(21) Appl. No.: 10/892,782

(22) Filed: Jul. 16, 2004

(30) Foreign Application Priority Data
Jul. 22, 2003 (JP) 2003-277528

(51) Int. Cl. G02F 1/136

(52) U.S. Cl. 349/44

(57) ABSTRACT

An active matrix substrate of the present invention has a substrate, a thin-film transistor and a capacitive element provided on the principal plane of the substrate, and a scanning line for supplying a scanning signal to the thin-film transistor, in which the thin-film transistor has a semiconductor layer including a channel region and a gate electrode formed on the semiconductor layer. The capacitive element is located at a position opposite to the substrate at the both sides of the thin-film transistor. The scanning line is formed by a conductive layer different from the gate electrode and located at a position closer to the substrate than the semiconductor layer.

### BACKGROUND OF THE INVENTION

1. Field of the Invention

The present invention relates to an active matrix substrate and a display device having the active matrix substrate, particularly to an active matrix substrate having a thin-film transistor and a capacitive element every pixel and a display device having the active matrix substrate.

2. Description of the Related Art

A liquid-crystal display has a feature that it is thin and consumes a small power and is widely used for various fields. Particularly, an active-matrix liquid-crystal display having a thin film transistor (referred to as TFT) as a driving element for each pixel has a high contrast ratio, a superior response characteristic, and a high performance. Therefore, the liquid-crystal display is used for a display portion of a personal computer or a portable television and its market scale has been expanded in recent years.

The market of a projection-type liquid-crystal display (so-called liquid-crystal projector) is expanded for business purposes and households and collects large remarks from the viewpoint of possibility.

Because a high brightness and a high fineness are requested for a liquid-crystal panel for a projector, it is preferable that the aperture ratio (pixel aperture ratio) of the panel is high. An important factor for raising the aperture ratio of the liquid-crystal panel is a capacitive element set onto to an active matrix substrate.

The capacitive element is set so as to form a storage capacitor electrically parallel with a liquid-crystal capacitor in order to hold a voltage applied to a liquid-crystal layer for a predetermined period and typically constituted by including a layer having a light shielding characteristic such as a metallic layer. Therefore, a region of a liquid-crystal panel where a capacitive element is set becomes a region through which light does not pass, that is, non-opening portion. Therefore, to raise the aperture ratio, it is preferable to decrease the area occupied by the capacitive element. However, when decreasing the area of the capacitive element, the capacitance value of the storage capacitor formed by the capacitive element decreases and this causes a displayed quality to deteriorate.

Thus, improvement of the aperture ratio and securing of a sufficient storage capacitor contradict to each other and there is a problem that it is difficult to combine them.

To solve the problem, Japanese Laid-Open Patent Publication Nos. 4-366924 and 2002-49048 disclose a method for setting a capacitive element above a TFT. In this method, a capacitive element overlaps with a region which originally becomes a non-opening portion such as a semiconductor layer of a TFT, a scanning line, or a signal line. Therefore, it is possible to secure the sufficient storage capacitor while restraining deterioration of the aperture ratio. Moreover, this method is effective from the viewpoint of preventing light from entering the TFT because the light incoming from the upper side of the TFT can be prevented by a capacitive element. In the structure disclosed in Japanese Laid-Open Patent Publication No. 2002-49048, because a light shielding film is formed below a TFT, it is possible to prevent the light incoming from the lower side of the TFT.

Thus, the structure for setting the capacitive element above the TFT is effective for a projector liquid-crystal panel which has important problems of restraining of bad influences due to incoming of strong light and downsizing.

However, because a projector liquid-crystal panel has been decreased in size and improved in aperture ratio in recent years, a light interruption region formed between pixels (specified by black matrix) is decreased in width and the following two problems occur.

The first problem is a problem relating to the arrangement of a contact hole for electrically connecting a pixel electrode to a thin film transistor.

A light shielding region is formed like a grid so as to include a region extending in almost parallel with a scanning line and a region extending in almost parallel with a signal line and a contact hole for pixel electrode is generally formed in a region extending in almost parallel with the scanning line so as not to overlap with the signal line. A contact hole for pixel electrode is further formed at a position not influenced by a step due to the scanning line, that is, a position not straddling the scanning line.

However, when the width of the light shielding region decreases, the versatility of formation of a contact hole for pixel electrode decreases and it is difficult to form the contact hole in the light shielding region. Therefore, the light shielding region is inevitably formed so that a portion corresponding to the contact hole protrudes and thereby, a numerical aperture is lowered due to the protruded portion.

As countermeasures for this problem, a method for decreasing the width of the scanning line or a method for increasing the width of the scanning line and overlapping the scanning line with the contact hole is considered.

However, in the case of the method for decreasing the width of the scanning line, because the resistance value of the scanning line increases, a delay of a scanning signal occurs and a scanning-directional flicker occurs when conducting a display.

Moreover, in the case of the method for increasing the width of the scanning line, a parasitic capacitance generated between an electrode electrically connected to a pixel electrode among capacitive electrodes constituting a capacitive element and the scanning line increases. When the parasitic capacitance between the scanning line and the capacitive element increases, a phenomenon that drop of a potential when a gate potential becomes off potential influences a pixel potential and thereby the pixel potential also lowers (lead-in of potential) becomes remarkable and thereby, a display characteristic is deteriorated.

The second problem is a problem of deterioration of light shielding characteristic.

When the width of the light interruption region decreases, the incoming quantity of light naturally increases. When the light is applied to the channel region or low-concentration impurity region (also referred to as Lightly Doped Drain region, that is, LDD region) of a TFT, the number of electrons optically pumped in a semiconductor layer increases and a leak current increases. Therefore, the potential of the pixel electrode lowers and a display quality is deteriorated. As disclosed in Japanese Laid-Open Patent Publication Nos. 4-366924 and 2002-49048, a capacitive element set above a TFT serves as a light shielding film but it is not possible to sufficiently prevent the light incoming from the transverse direction due to irregular reflection of light in a substrate.

### SUMMARY OF THE INVENTION

The present invention is made to solve the above problems and its object is to provide an active matrix substrate capable of improving a numerical aperture without deteriorating a display quality and a display device having the active matrix substrate.

An active matrix substrate of the present invention is an active matrix substrate including a substrate, a thin-film transistor and a capacitive element provided on the principal plane of the substrate, and a scanning line for supplying a scanning signal to the thin-film transistor. The thin-film transistor includes a semiconductor layer including a channel region and a gate electrode electrically connected to the scanning line and set to a position more separate from the substrate than the semiconductor layer. The capacitive element is located at a position opposite to the substrate at the both sides of the thin-film transistor and the scanning line is formed by a conductive layer different from the gate electrode and located at a position closer to the substrate than the semiconductor layer, and thereby the above object is achieved.

In a preferred embodiment, when viewed from the normal direction of the substrate, the capacitive element and the scanning line overlap with the channel region of the semiconductor layer.

In a preferred embodiment, the capacitive element includes a capacitive dielectric film and a first capacitive electrode and a second capacitive electrode opposite to each other through the capacitive dielectric film.

In a preferred embodiment, at least either of the first capacitive electrode and second capacitive electrode and the scanning line have a light shielding characteristic.

In a preferred embodiment, an active matrix substrate of the present invention includes a pixel electrode electrically connected to the thin-film transistor, in which a pixel-electrode contact hole for electrically connecting the pixel electrode with the thin-film transistor overlaps with the scanning line when viewed from the normal direction of the substrate.

In a preferred embodiment, the semiconductor layer includes a source region and a drain region opposite to each other at the both sides of the channel region, the first capacitive electrode is electrically connected to the drain region, the pixel-electrode contact hole is formed between the first capacitive electrode and the pixel electrode, the pixel electrode and the first capacitive electrode are electrically mutually connected at the pixel-electrode contact hole, and the pixel electrode is electrically connected to the thin-film transistor via the first capacitive electrode.

In a preferred embodiment, the gate electrode and the scanning line are electrically connected each other at at least two gate contact holes formed at a side of the channel region and at least the two gate contact holes include a pair of gate contact holes located at the mutually opposite side to the channel region.

In a preferred embodiment, the semiconductor layer includes a source region and a drain region opposite to each other at the both sides of the channel region and moreover, has a low-concentration impurity region between the channel region and the source region and between the channel region and the drain region respectively.

In a preferred embodiment, when viewed from the normal direction of the substrate, the capacitive element and the scanning line overlap with the low-concentration impurity region of the semiconductor layer.

A display device of the present invention includes an active matrix substrate having the above mentioned structure and a display medium layer provided on the active matrix substrate and thereby, the above object is achieved.

In a preferred embodiment, a display device of the present invention has a first light shielding region extending along a first direction in which the scanning line extends and a second light shielding region extending along a second direction crossing in the first direction.

In a preferred embodiment, the channel region is located at almost the center of the crossing portion between the first light shielding region and the second light shielding region.

In a preferred embodiment, when viewed from the normal direction of the substrate, at least a part of the gate electrode overlaps with the crossing portion between the first light shielding region and the second light shielding region.

In a preferred embodiment, the display medium layer includes a liquid-crystal material.

In a preferred embodiment, a display device of the present invention is a projection-type liquid-crystal display device having a projection optical system.

The present invention provides an active matrix substrate capable of improving a numerical aperture without deteriorating a display quality and a display device having the active matrix substrate.

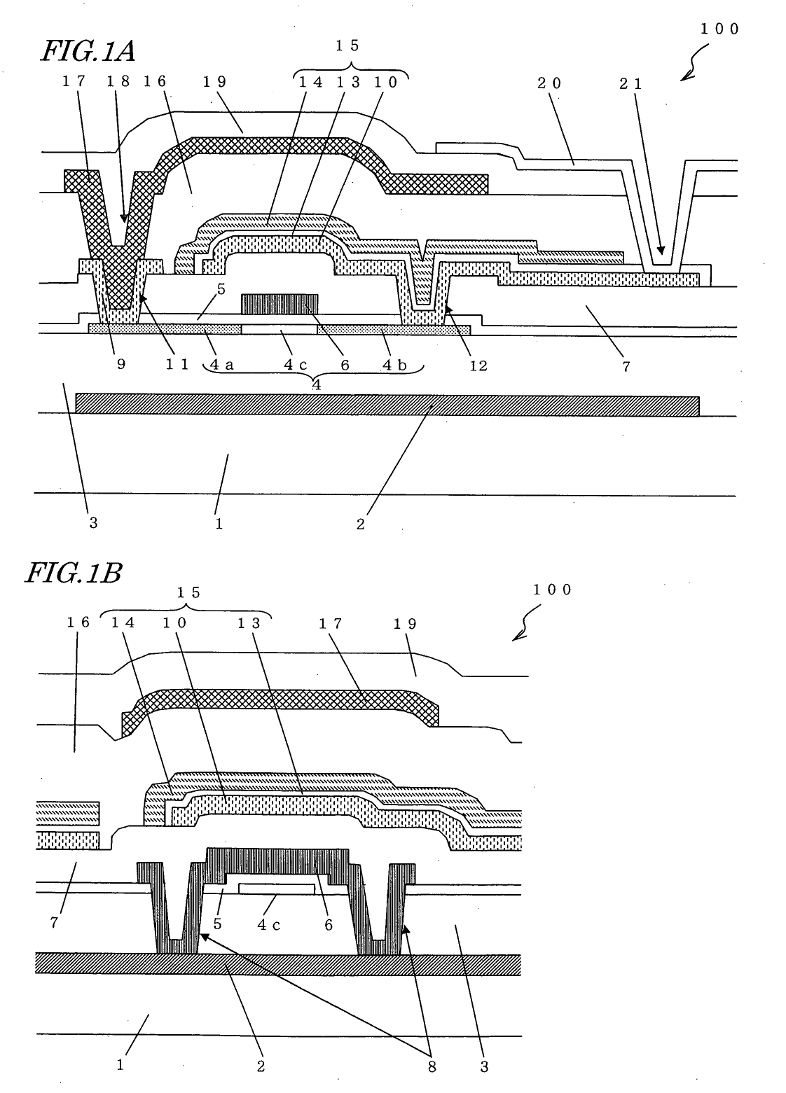

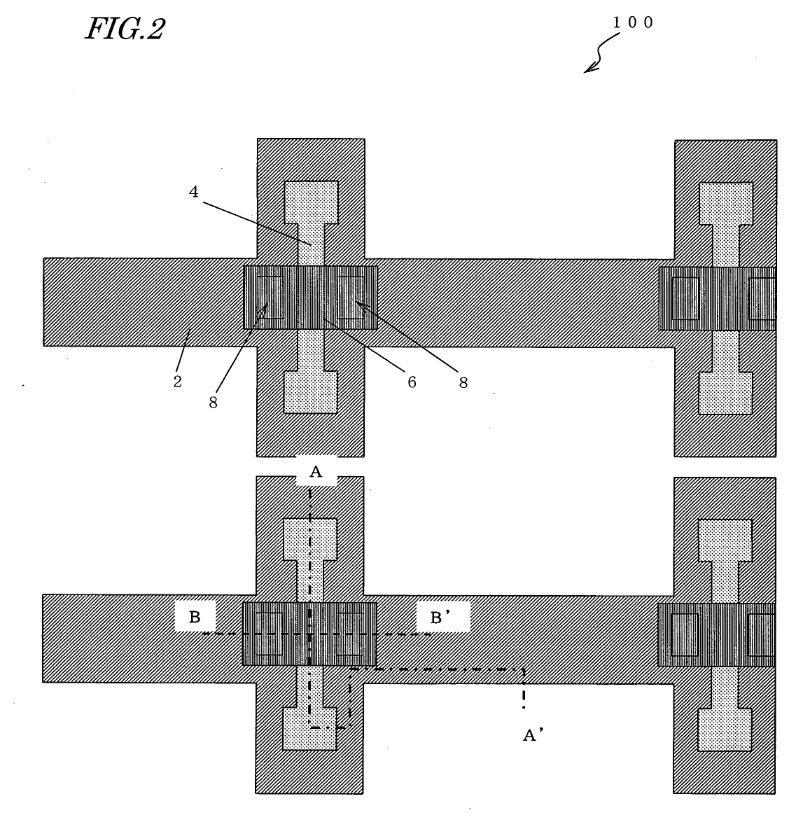

FIG. 1A shows a sectional view along the line A-A′ in FIGS. 2 to 4 and

FIG. 1B shows a sectional view along the line B-B′ in FIGS. 2 to 4.

FIG. 2 is a top view schematically showing the active matrix substrate 100 of the present invention.

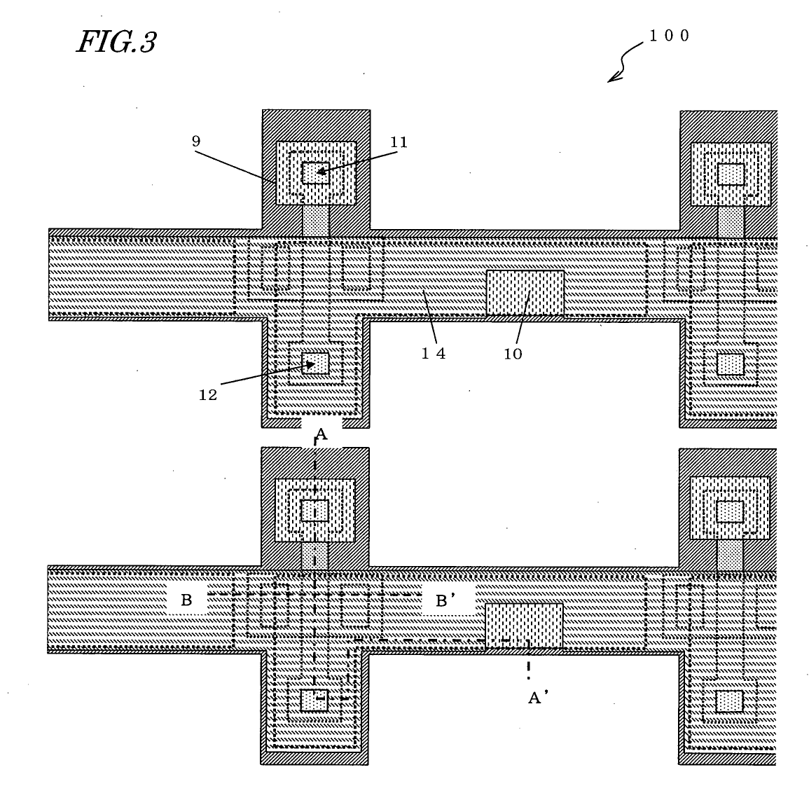

FIG. 3 is a top view schematically showing the active matrix substrate 100 of the present invention.

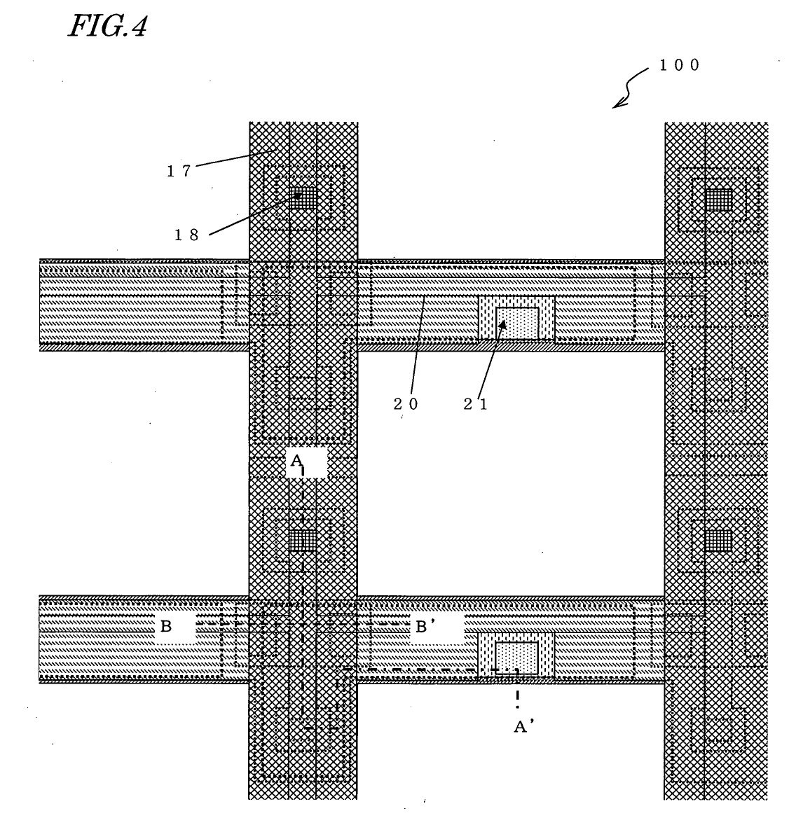

FIG. 4 is a top view schematically showing the active matrix substrate 100 of the present invention.

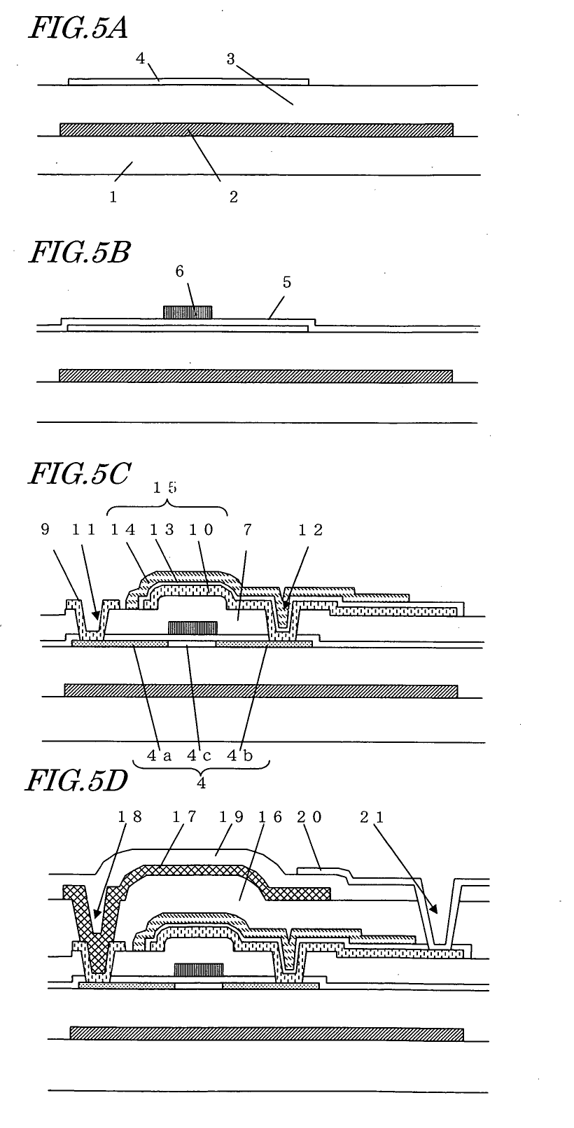

FIGS. 5A to 5D are sectional views schematically showing a fabrication process of the active matrix substrate 100.

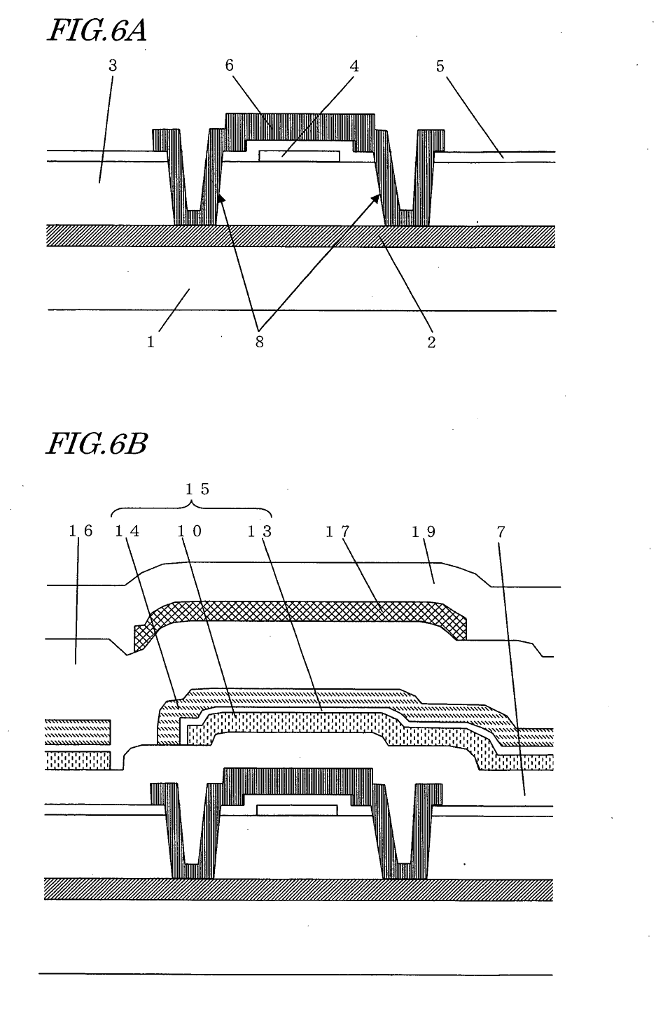

FIGS. 6A and 6B are sectional views schematically showing a fabrication process of the active matrix substrate 100.

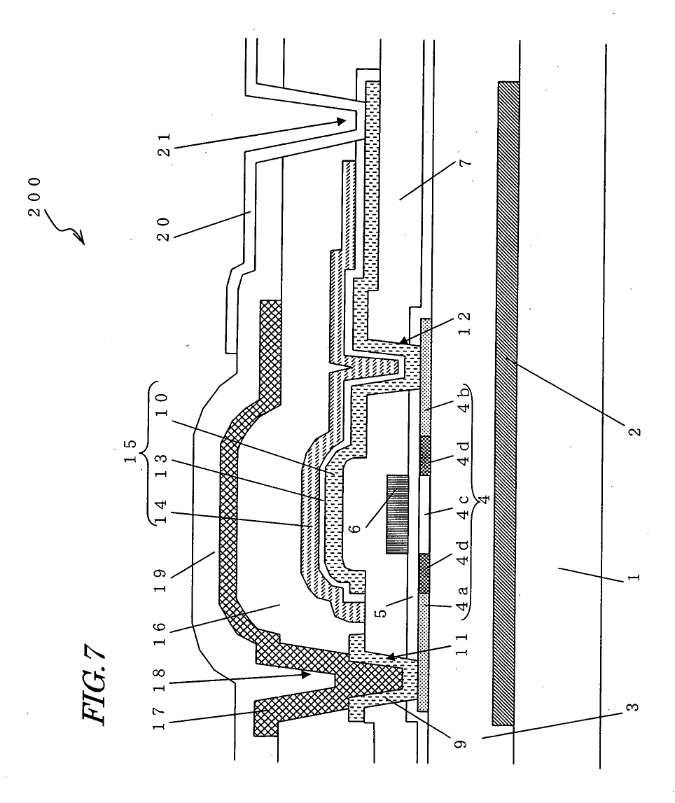

FIG. 7 is a sectional view schematically showing another active matrix substrate 200 of the present invention.

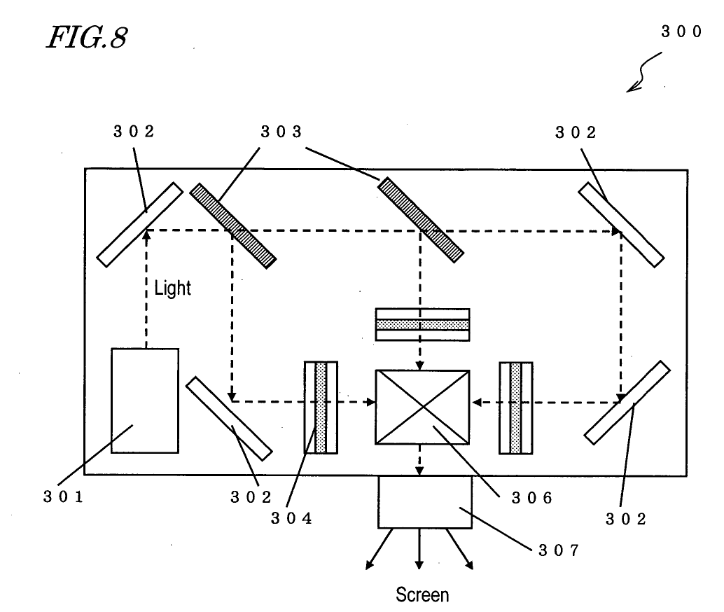

FIG. 8 is an illustration schematically showing an injection-type liquid-crystal display 300 of the present invention.

### DETAILED DESCRIPTION OF THE PREFERRED EMBODIMENTS

An active matrix substrate of the present invention has a substrate, a thin-film transistor (TFT) and a capacitive element provided on the principal plane of the substrate and a scanning line for supplying a scanning signal to the thin-film transistor. The active matrix substrate is used for a display device and has a plurality of pixels respectively serving as the unit for display. The thin-film transistor and capacitive element are typically set every pixel.

The thin-film transistor has a semiconductor layer including a channel region and a gate electrode electrically connected to the scanning line and set at a position more separate from the substrate than the semiconductor layer. When using the active matrix substrate for a liquid-crystal display device, the thin-film transistor functions as a switching device and a display signal is transferred to the pixel electrode through the turned-on thin-film transistor. The display signal is supplied to the thin-film transistor through a signal line set so as to cross the scanning line.

The capacitive element typically has a capacitive dielectric film and a pair of capacitive electrodes opposite to each other through the capacitive dielectric film. When using the active matrix substrate for a liquid-crystal display, the capacitive element is set so that a storage capacitor is electrically added to a liquid-crystal capacitor in parallel to prevent a display quality from deteriorating by holding the potential of the pixel electrode for a predetermined period.

In the active matrix substrate of the present invention, the capacitive element is located at a position opposite to the substrate at the both sides of the thin-film transistor. That is, the thin-film transistor is located between the capacitive element and the substrate.

In general, when light enters the channel region of the thin-film transistor, a leak current when the thin-film transistor is turned off increases. Therefore, it is necessary to shade the channel region from light. In the active matrix substrate of the present invention, the capacitive element is located at a position opposite to the substrate at the both sides of the thin-film transistor. Therefore, even when a light shielding layer is set to shade the channel region from light, the light shielding layer can be set so as to overlap with the capacitive element and it is possible to overlap a region in which a transparency is deteriorated by the capacitive element with a region in which a light shielding layer is formed. As a result, it is possible to restrain the area in which the transparency is deteriorated from increasing by the capacitive element and an aperture ratio from lowering.

Moreover, in the active matrix substrate of the present invention, the scanning line is formed by a conductive layer different from the gate electrode and set to a position closer to the substrate than the semiconductor layer. That is, the scanning line is set to a position opposite to the gate electrode and capacitive element. Therefore, it is possible to sufficiently increase the interval between the capacitive electrode constituting the capacitive element and the scanning line and sufficiently decrease the value of a parasitic capacitance generated between them. Therefore, to restrain the delay of the scanning signal and superimpose a pixel-electrode contact hole on the scanning line, even if increasing the width of the scanning line, increase of the parasitic capacitance generated between the scanning line and the capacitive electrode does not substantially become a problem and it is possible to retrain a display quality from deteriorating.

Thus, according to the present invention, it is possible to improve the aperture ratio without deteriorating the display quality.

Moreover, in the active matrix substrate of the present invention, the gate electrode and the scanning line are located at positions opposite to each other at the both sides of the semiconductor layer. Therefore, it is possible to form a gate contact hole for electrically connecting the gate electrode with the scanning line to a side of the channel region and effectively interrupt the light incoming from the side to the channel region by a conductive layer formed in the gate contact hole. Therefore, the active matrix substrate of the present invention has a structure superior to shade the channel region from light. Moreover, because the scanning line is located at a position opposite to the gate electrode at the both sides of the semiconductor layer, advantages can be obtained that it is possible to increase the on-current of a thin-film transistor by the effect of the potential of the scanning line and preferably write a display signal in a pixel.

Because the active matrix substrate of the present invention can realize a high aperture ratio without deteriorating the display quality, it is preferably used as a liquid-crystal-device substrate particularly used for a projection-type liquid-crystal display. In the liquid-crystal device used for the projection-type liquid-crystal display, it is necessary to apply the light stronger than the case of a normal liquid-crystal display. Therefore, there are problems that incident light or the light reflected from the back of the substrate easily enters the channel region and the display quality is remarkably deteriorated. However, because the active matrix substrate of the present invention has the structure superior to shade the channel region from light, it is possible to solve the above problems.

The capacitive element and the scanning line are typically arranged so that they overlap with the channel region of the thin-film transistor when viewed from the normal direction of the substrate. In this case, when at least either of a pair of capacitive electrodes constituting the capacitive element has a light shielding characteristic, the capacitive element functions as a light shielding layer for interrupting the light incoming to the channel region. Moreover, when the scanning line has a light shielding characteristic, it functions as a light shielding layer for interrupting the light incoming to the channel region. When at least either of the capacitive electrodes and the scanning line has a light shielding characteristic, an advantage is obtained that it is not necessary to separately form a light shielding layer for shading the channel region from light.

An embodiment of the present invention is described below by referring to FIGS. 1 to 4. An active matrix substrate used for a liquid-crystal display is illustrated below.

A configuration of the active matrix substrate 100 of this embodiment is described below by referring to FIGS. 1 to 4. FIGS. 1A and 1B show sectional structures of the active matrix substrate 100 and FIGS. 2 to 4 show top configurations of the active matrix substrate 100. FIGS. 1A and 1B show cross sections along the line A-A′ and line B-B′ in FIGS. 2 to 4 and some of components are omitted in FIGS. 2 and 3 for easy understanding.

As shown in FIG. 1A, the active matrix substrate 100 has an insulating substrate (e.g. quartz substrate) 1 and a scanning line (gate line) 2 is formed on the principal plane of the insulating substrate 1. In this embodiment, the scanning line 2 is formed by a light shielding material. Moreover, a first interlayer insulating film 3 is formed on the substrate 1 so as to cover the scanning line 2.

A TFT semiconductor layer 4 is formed on the first interlayer insulating film 3. The TFT semiconductor layer 4 includes a channel region 4c and a source region 4a and a drain region 4b which are faced at the both sides of the channel region 4c. As shown in FIG. 2, the channel region 4c of the TFT semiconductor layer 4 overlaps with the scanning line 2 when viewed from the normal direction of the substrate. Because the scanning wring 2 has the light shielding characteristic, the light incoming to the channel region 4c from the back of the substrate 1 is interrupted by the scanning line 2.

A gate oxide film 5, gate electrode 6, and second interlayer insulating film 7 are formed in order on the TFT semiconductor layer 4 from the substrate 1. As shown in FIG. 1B, the gate electrode 6 is connected to the scanning line 2 at the gate contact holes 8 formed on the first interlayer insulating film 3 and gate oxide film 5. In this embodiment, two gate contact holes 8 are formed at sides of the channel region. These contact holes 8 are located at the opposite side each other to the channel region 4c.

A source electrode 9 and a drain electrode 10 are formed on the second interlayer insulating film 7. The source electrode 9 is connected to the source region 4a of the TFT at a first source contact hole 11 formed on the gate oxide film 5 and second interlayer insulating film 7. Moreover, the drain electrode 10 is connected to the drain region 4b of the TFT at a drain contact hole 12 formed on the gate oxide film 5 and second interlayer insulating film 7. In this embodiment, the drain electrode 10 also functions as either (first capacitive electrode) of the capacitive electrodes constituting a capacitive element 15.

A capacitive dielectric film 13 and a second capacitive electrode 14 are formed in order on the first capacitive electrode (drain electrode) 10 from the substrate 1. The capacitive element 15 is constituted by the capacitive dielectric film 13, the first capacitive electrode 10 and second capacitive electrode 14 faced each other through the capacitive dielectric film 13. As shown in FIG. 3, the first capacitive electrode 10 is a conductive layer formed by being divided every pixel and the second capacitive electrode 14 is a part of a capacitance line extended almost in parallel with the scanning line 2. A predetermined potential is applied to the capacitance line from the outside and a common potential is applied to the second capacitive electrode 14 belonging to the same capacitance line. Typically, a potential common to all capacitance lines is applied. The capacitance line may be like a grid extending along the direction in which the scanning line 2 extends and the other direction in which a signal line 17 extends.

As shown in FIG. 3, the capacitive element 15 including the first capacitive electrode 10 and second capacitive electrode 14 overlap with the channel region 4c of the TFT semiconductor layer 4 when viewed from the normal direction of the substrate. In this embodiment, at least either of the first capacitive electrode 10 and second capacitive electrode 14 is formed by a light shielding material and the light incoming to the channel region 4c from the upper portion of the TFT is interrupted by the capacitive element 15.

A third interlayer insulating film 16 is formed so as to cover the capacitive element 15 and a signal line 17 is formed on the third interlayer insulating film 16. The signal line 17 is connected to the source electrode 9 at a second source contact hole 18 formed on the third interlayer insulating film 16.

A fourth interlayer insulating film 19 is formed on the third interlayer insulating film 16 and signal line 17 and a pixel electrode 20 is formed in a predetermined region on the fourth interlayer insulating film 19. The pixel electrode 20 is connected to the first capacitive electrode (drain electrode) 10 at a pixel electrode contact hole 21 formed in the capacitance dielectric film 13, the third interlayer insulating film 16 and the fourth interlayer insulating film 19 and electrically connected to the TFT through the first capacitive electrode 10. In this embodiment, the pixel electrode contact hole 21 for electrically connecting the pixel electrode 20 and the thin film transistor each other overlaps with the scanning line 2 when viewed from the normal direction of the substrate as shown in FIGS. 1A and 4.

In the active matrix substrate 100 of the present invention, the capacitive element 15 is located at a position opposite to the substrate 1 at the both sides of a thin-film transistor. Therefore, even when forming a light shielding layer in order to shade the channel region 4c from light, it is possible to form the light shielding layer so as to overlap with the capacitive element 15 and overlap a region in which a transmittance is deteriorated by the capacitive element 15 with a region in which a light shielding layer is formed in the substrate surface. As a result, it is possible to restrain the area in which a transmittance is deteriorated from increasing by the capacitive element 15 and secure a sufficient storage capacitance while restraining the aperture ratio from lowering.

Moreover, in the active matrix substrate 100, the scanning line 2 is formed by a conductive layer different from the gate electrode 6 and formed at a position closer to the substrate 1 than the TFT semiconductor layer 4. Therefore, it is possible to sufficiently increase the interval between the scanning line 2 and the first capacitive electrode 10 and sufficiently decrease the value of the parasitic capacitance generated between them. Therefore, even if the width of the scanning line 2 is increased like this embodiment in order to overlap the pixel-electrode contact hole 21 with the scanning line 2, increase of the parasitic capacitance generated between the scanning line 2 and the first capacitive electrode 10 does not substantially become a problem and it is possible to restrain the display quality from deteriorating.

From the viewpoint of sufficiently decreasing the value of the parasitic capacitance generated between the scanning line 2 and the first capacitive electrode 10, it is preferable that the total of thicknesses of the first interlayer insulating film 3 and the second interlayer insulating film 7 for separating the scanning line 2 from the first capacitive electrode 10 is 600 nm or more, more preferable that the total is 1,000 nm or more. However, when extremely increasing only either of thicknesses of the first interlayer insulating film 3 and the second interlayer insulating film 7, a problem may occur that it is difficult to form a contact hole. Therefore, it is preferable that the thickness of the first interlayer insulating film 3 ranges between 300 and 800 nm (both included) and the thickness of the second interlayer insulating film 7 ranges between 300 and 800 nm (both included).

Thus, the present invention makes it possible to improve the aperture ratio without deteriorating the display quality.

Moreover, in the active matrix substrate 100, the gate electrode 6 is located at a position opposite to the scanning line 2 at the both sides of the TFT semiconductor layer 4. Therefore, it is possible to form the gate contact hole 8 at a side of the channel region 4c as shown in FIG. 1B and the like and effectively interrupt the light incoming to the side of the channel region 4c by a conductive layer (conductive layer integrally formed with the gate electrode 6) formed in the gate contact hole 8. Therefore, the active matrix substrate 100 has a structure superior to shade the channel region 4c from light. Moreover, because the scanning line 2 is located at the position opposite to the gate electrode 6 (in this case, below the TFT) at the both sides of the TFT semiconductor layer 4, it is possible to increase the on-current of the thin-film transistor in accordance with the effect of the potential of the scanning line 2 and moreover, an advantage can be obtained that it is possible to preferably write a display signal in a pixel.

When the capacitive element 15 and scanning line 2 are arranged so that they overlap with the channel region 4c of the thin-film transistor when viewed from the normal direction of the substrate and at least either of the first capacitive electrode 10 and second capacitive electrode 14 has the light shielding characteristic, the capacitive element 15 also functions as the light shielding layer for interrupting the light incoming to the channel region 4c. Moreover, when the scanning line 2 has the light shielding characteristic, it also functions as the light shielding layer for interrupting the light incoming to the channel region 4c. It is not always necessary that the first capacitive electrode 10, second capacitive electrode 14, and scanning line 2 have the light shielding characteristic. However, when they have the light shielding characteristic, an advantage is obtained that it is not necessary to separately form the light shielding layer.

From the viewpoint of effectively interrupting the light incoming from a side of the channel region 4c, it is preferable to form at least two gate contact holes including a pair of gate contact holes 8 (located at positions opposite to each other at the both sides of the channel region 4c) for holding the channel region 4c.

The active matrix substrate 100 is preferably used for a display device because it can improve the aperture ratio without deteriorating the display quality. The display device having the active matrix substrate 100 typically further includes a display medium layer set on the active matrix substrate 100. In the liquid-crystal display, a display medium layer is a liquid-crystal layer including a liquid-crystal material, which is attached so that the active matrix substrate 100 and an opposite substrate are faced each other through the liquid-crystal layer.

Moreover, because the active matrix substrate 100 of the present invention has the structure superior to shade the channel region 4c from light, it is particularly preferably used for a liquid-crystal device for a projection-type liquid-crystal display device which the light stronger than the normal state enters. The projection-type liquid-crystal display typically has a projection optical system including a light source, liquid-crystal device, and projection lens.

Moreover, the display device is typically provided with a light shielding region for demarcating each pixel (light transmitting section of each pixel). For example, a grid-like light shielding region is formed which is constituted by a first striped light shielding region extending along the direction in which the scanning line 2 extends and a second striped light shielding region extending along the direction in which the signal line 17 extends (typically, direction almost orthogonal to the direction in which the scanning line 2 extends). When the light shielding region is formed, it is preferable that the channel region 4c of the TFT semiconductor layer 4 is located at almost the center of the intersecting portion between the first light shielding region and the second light shielding region from the viewpoint of effectively preventing the light from entering the channel region 4c.

Moreover, a portion of the surface of the active matrix substrate 100 corresponding to a region in which the gate electrode 6 is formed becomes a convex portion (step portion) reflecting the shape of the gate electrode 6. In the liquid-crystal display, the convex portion (step portion) is a portion different from other flat portion in inclination of a liquid-crystal molecule and imperfect orientation easily occurs at this convex portion. Therefore, the display quality may be deteriorated because light leakage occurs. From the viewpoint of effectively shading the convex portion from light in order to retrain the display quality from deteriorating, it is preferable that at least a part of the gate electrode 6 (and the channel region 4c below the electrode 6) overlaps with the intersecting portion between the first and second light shielding regions and a maximum number of portions overlap.

The above active matrix substrate 100 can be fabricated as described below. By referring to FIGS. 5A to 5D and FIGS. 6A and 6B, a fabrication method of the active matrix substrate 100 is described below.

As shown in FIG. 5A, the scanning line 2, first interlayer insulating film 3, and TFT semiconductor layer 4 are formed on the substrate 1.

Specifically, the insulating substrate 1 formed by quartz is first prepared and then, a polycrystalline silicon (poly-Si) film doped with phosphor at a high concentration and a tungsten silicide (WSi) film are continuously deposited on the substrate 1 at a thickness of approx. 150 nm respectively to form the scanning line 2 by patterning the laminated film into a predetermined shape through general photolithography and dry etching.

Then, by using the CVD method and thereby depositing a silicon oxide film having a thickness of approx. 400 nm for covering the scanning line 2 on the substrate 1, the first interlayer insulating film 3 is formed. Then, an amorphous silicon film having a thickness of approx. 50 nm is deposited on the first interlayer insulating film 3 to form a crystalline silicon film by crystallizing the amorphous silicon film. Then, the TFT semiconductor layer 4 is formed by pattering the crystalline silicon film into a predetermined shape through photolithography and dry etching. To crystallize the amorphous silicon film, it is possible to use a method for heating the amorphous silicon film up to 600° C. or higher or a method for applying an excimer laser beam to the film. A region of the TFT semiconductor layer to later become the channel region 4c is formed so as to overlap with the scanning line 2 when viewed from the normal direction of the substrate.

Then, as shown in FIGS. 5B and 6A, the gate oxide film 5 and gate electrode 6 are formed on the TFT semiconductor layer 4.

Specifically, the gate oxide film 5 is formed by depositing a silicon oxide film having a thickness of approx. 80 nm on the TFT semiconductor layer 4 to improve the quality of the gate oxide film 5 by performing an annealing treatment at a temperature of 900° C. or higher in an atmosphere containing oxygen or chlorine.

Then, the gate contact hole 8 is formed through photolithography or dry etching so that a part of the scanning line 2 is exposed to the first interlayer insulating film 3. Then, a polycrystalline silicon (poly-Si) film having a thickness of approx. 400 nm doped with phosphor at a high concentration is deposited and patterned into a predetermined shape through photolithography and dry etching to form the gate electrode 6.

Then, as shown in FIG. 5C, the source region 4a, drain region 4b, and channel region 4c are formed on the TFT semiconductor layer 4 and the second interlayer insulating film 7, source electrode 9, first capacitive electrode (drain electrode) 10, capacitive dielectric film 13, and second capacitive electrode 14 are formed on the TFT semiconductor layer 4, the gate oxide film 5 and gate electrode 6.

Specifically, the source region 4a and drain region 4b which are high-concentration impurity regions are formed by using the gate electrode 6 as a mask and implanting phosphor having a dose amount of 2×10¹⁵ atoms/cm² into the TFT semiconductor layer 4 with acceleration energy of 75 keV. In this case, a portion of the TFT semiconductor layer 4 into which phosphor is not implanted because the portion is located below the gate electrode 6 becomes the channel region 4c.

Then, by using the CVD method and thereby depositing a silicon oxide film having a thickness of approx. 500 nm for covering almost the entire surface of the substrate, the second interlayer insulating film 7 is formed and then, the phosphor implanted into the source region 4a and drain region 4b is activated by applying a heat treatment to the film 7 for 30 min at 950° C.

Then, the first source contact hole 11 is formed on the gate oxide film 5 and second interlayer insulating film 7 through photolithography and wet etching or dry etching so as to expose a part of the source region 4a and the drain contact hole 12 is formed so as to expose a part of the drain region 4b.

Thereafter, a polycrystalline silicon (poly-Si) film having a thickness of approx. 200 nm doped with phosphor at a high concentration is deposited to form the source electrode 9 and first capacitive electrode (drain electrode) 10 by patterning the polycrystalline silicon film into a predetermined shape.

Then, the capacitive electrode 13 is formed by depositing a silicon oxide film having a thickness of approx. 30 nm for covering the first capacitive electrode 10 and then, the film 13 is annealed at a temperature of 900° C. or higher in an atmosphere containing oxygen or chlorine.

Then, a polycrystalline silicon (poly-Si) film doped with phosphor at a high concentration and a tungsten silicide (WSi) film are continuously deposited on almost the entire surface of the substrate at a thickness of approx. 150 nm and are patterned into predetermined shapes through general photolithography and dry etching to form a capacitance line extending along the direction in which the scanning line 2 extends. The capacitance line is continued up to the outside of the display portion and constituted so that a voltage for the capacitance line can be applied from the outside. A portion of the capacitance line overlapping with the first capacitive electrode 10 formed every pixel functions as the second capacitive electrode 14.

Thereafter, the third interlayer insulating film 16, signal line 17, fourth interlayer insulating film 19, and pixel electrode 20 are formed on them as shown in FIGS. 5D and 6B.

Specifically, the third interlayer insulating film 16 is formed by using the CVD method and thereby depositing a silicon oxide film having a thickness of approx. 500 nm on almost the entire surface of the substrate, and then the second source contact hole 18 is formed on the third interlayer insulating film 16 through photolithography and wet etching or dry etching so that a predetermined region of the source electrode 9 is exposed.

Then, a laminated layer obtained by successively laminating a TiW film having a thickness of approx. 100 nm, an AlSi film having a thickness of approx. 400 nm, and a TiW film having a thickness of approx. 100 nm is deposited and patterned into a predetermined shape through photolithography and dry etching to form the signal line 17.

Then, the fourth interlayer insulating film 19 is formed by depositing a silicon oxide film having a thickness of approx. 300 nm and the pixel-electrode contact hole 21 is formed on the fourth interlayer insulating film 19 through photolithography and wet etching or dry etching so that a predetermined region of the first capacitive electrode 10 is exposed.

Thereafter, an ITO film having a thickness of approx. 100 nm is deposited on the fourth interlayer insulating film 19 to form the pixel electrode 20 by patterning the ITO film into a predetermined shape through photolithography and dry etching.

Thus, the active matrix substrate 100 is fabricated.

Then, another active matrix substrate 200 of the present invention is described below by referring to FIG. 7. In FIG. 7, a component substantially having the same function as a component of the active matrix substrate 100 is provided with the same reference symbol.

The active matrix substrate 200 is different from the active matrix substrate 100 in that a low-concentration impurity region (also referred to as Lightly Doped Drain region, that is, LDD region) 4d is formed between the channel region 4c and source region 4a and between the channel region 4c and the drain region 4b of the TFT semiconductor layer 4.

In the active matrix substrate 200, because the TFT semiconductor 4 has a low-concentration impurity region 4d doped with an impurity such as phosphor at a low concentration, the off-current of the TFT decreases and it is possible to further improve the display quality.

Incoming of light to the low-concentration impurity region 4d causes off-current to increase. Therefore, it is preferable that the low-concentration impurity region 4d is shaded from light similarly to the channel region 4c. When using a configuration in which the capacitive element 15 and the scanning line 2 overlap with the low-concentration impurity region 4d when viewed from the normal direction of a substrate, it is possible to shade the low-concentration impurity region from light without separately forming a light shielding layer by providing the light shielding characteristic for the capacitive element 15 and scanning line 2.

The active matrix substrate 200 can be fabricated as described below.

First, up to the gate electrode 6 is fabricated by using the same process as the fabrication method described for the active matrix substrate 100.

Then, phosphor having a dose amount of 2×10¹³ atoms/cm² is implanted into the TFT semiconductor layer 4 at acceleration energy of 75 keV by using the gate electrode 6 as a mask and then, a mask made of photoresist is formed on a region of the TFT semiconductor layer 4 to serve as the low-concentration impurity region 4d later and phosphor having a dose amount of 2×10¹⁵ atoms/cm² is implanted at acceleration energy of 75 keV. In this step, the source region 4a and drain region 4b into which high-concentration phosphor is implanted and the low-concentration impurity region 4d into which low-concentration phosphor is implanted are formed. In this case, the channel region 4c is formed into which no phosphor is implanted because it is located below the gate electrode 6.

Thereafter, by using the same process as the fabrication method described for the active matrix substrate 100 and forming up to the pixel electrode 21, the active matrix substrate 200 is finished.

Because the active matrix substrates 100 and 200 of the present invention have the structure superior to shade the channel region 4c from light, they are respectively preferably used for a liquid-crystal device 304 of the projection-type liquid-crystal display device 300 shown in FIG. 8.

The projection-type liquid-crystal display device 300 includes a light source (lamp unit) 301, liquid-crystal device 304 for modulating the light emitted from the light source 301, and a projection lens unit (projection optical system) 307 for projecting the light modulated by the liquid-crystal device 304 to a screen. Three liquid-crystal devices 304 are used correspondingly to color light beams of R, G, and B.

The projection-type liquid-crystal display 300 further includes a plurality of mirrors 302 for reflecting light and making the light enter each component at a predetermined angle, dichroic mirror 303 for dividing light into a plurality of color light beams, and a prism 306 for synthesizing a plurality of color light beams modulated by the liquid-crystal device 304.

In the projection-type liquid-crystal display 300, a light source for emitting the light stronger than the light of a backlight for a normal transmission-type liquid-crystal display is used as the light source 301. However, by using the active matrix substrate 100 or 200 of the present invention for the liquid-crystal device 304, it is possible to improve the aperture ratio without deteriorating the display quality. In this case, a three-plate projection-type liquid-crystal display device is illustrated. However, an active matrix substrate of the present invention is also preferably used for a single-plate projection-type liquid-crystal display device.

Because the active matrix substrate of the present invention makes it possible to improve the aperture ratio without deteriorating the display quality, it is preferable used as the active matrix substrate for the liquid-crystal device for the display device such as the liquid-crystal display.

Moreover, because the active matrix substrate of the present invention has the structure superior to shade the channel region of the TFT from light, it is preferably used as the active matrix substrate for the liquid-crystal device of the projection-type liquid-crystal display device.

This non-provisional application claims priority under 35 USC § 119(a) on Patent Application No. 2003-277528 filed in Japan on Jul. 22, 2003, the entire contents of which are hereby incorporated by reference.

1. An active matrix substrate comprising a substrate, a thin-film transistor and a capacitive element provided on the principal plane of the substrate, and a scanning line for supplying a scanning signal to the thin-film transistor, wherein
the thin-film transistor includes a semiconductor layer including a channel region and a gate electrode electrically connected to the scanning line and set to a position more separate from the substrate than the semiconductor layer,
the capacitive element is located at a position opposite to the substrate at the both sides of the thin-film transistor, and
the scanning line is formed by a conductive layer different from the gate electrode and located at a position closer to the substrate than the semiconductor layer.

2. The active matrix substrate according to claim 1, wherein
the capacitive element and the scanning line overlap with the channel region of the semiconductor layer when viewed from the normal direction of the substrate.

3. The active matrix substrate according to claim 1, wherein
the capacitive element includes a capacitive dielectric film and a first capacitive electrode and a second capacitive electrode faced each other through the capacitive dielectric film.

4. The active matrix substrate according to claim 3, wherein
at least either of the first capacitive electrode and the second capacitive electrode has a light shielding characteristic, and
the scanning line has a light shielding characteristic.

5. The active matrix substrate according to claim 1, further comprising a pixel electrode electrically connected to the thin-film transistor is included, and wherein
a pixel-electrode contact hole for electrically connecting the pixel electrode with the thin-film transistor overlaps with the scanning line when viewed from the normal direction of the substrate.

6. The active matrix substrate according to claim 5, wherein
the semiconductor layer includes a source region and a drain region faced each other at the both sides of the channel region,
the first capacitive electrode is electrically connected to the drain region,
the pixel-electrode contact hole is formed between the first capacitive electrode and the pixel electrode and the pixel electrode and the first capacitive electrode are electrically connected each other at the pixel-electrode contact hole, and
the pixel electrode is electrically connected to the thin-film transistor via the first capacitive electrode.

7. The active matrix substrate according to claim 1, wherein
the gate electrode and the scanning line are electrically connected at least two gate contact holes formed at a side of the channel region, and
at least the two contact holes include a pair of gate contact holes located at positions opposite to each other at the both sides of the channel region.

8. The active matrix substrate according to claim 1, wherein
the semiconductor layer includes a source region and a drain region faced each other at the both sides of the channel region and moreover has a low-concentration impurity region between the channel region and the source region and between the channel region and the drain region.

9. The active matrix substrate according to claim 8, wherein
when viewed from the normal direction of the substrate, the capacitive element and the scanning line overlap with the low-concentration impurity region of the semiconductor layer.

10. A display device comprising the active matrix substrate of claim 1 and a display medium layer provided on the active matrix substrate.

11. The display device according to claim 10, further comprising a first light shielding region extending along a first direction in which the scanning line extends and a second light shielding region extending along a second direction crossing the first direction.

12. The display device according to claim 11, wherein
the channel region is located at almost the center of the crossing portion between the first light shielding region and the second light shielding region.

13. The display device according to claim 11, wherein
when viewed from the normal direction of the substrate, at least a part of the gate electrode overlaps with the crossing portion between the first light shielding region and the second light shielding region.

14. The display device according to claim 10, wherein
the display medium layer contains a liquid-crystal material.

15. The display device according to claim 10, which is a projection-type liquid-crystal display device including a projection optical system.
